(19) United States
(12) Patent Application Publication
(10) Pub. No.: US 2026/0128493 A1
(43) Pub. Date: May 7, 2026

(54) ELECTRONIC COMPONENT

(71) Applicant: TDK CORPORATION, Tokyo (JP)

(72) Inventor: Takeshi OOHASHI, Tokyo (JP)

(73) Assignee: TDK CORPORATION, Tokyo (JP)

(21) Appl. No.: 19/378,850

(22) Filed: Nov. 4, 2025

(30) Foreign Application Priority Data
Nov. 5, 2024 (JP) 2024-193525

(51) Int. Cl. H01P 5/18

(52) U.S. Cl. CPC H01P 5/187

(57) ABSTRACT

An electronic component includes a base body having a mounting surface and a main surface facing each other, a first electrode, a second electrode, a third electrode, and a fourth electrode disposed on the mounting surface, a first transmission line electrically connecting the first electrode and the second electrode, a second transmission line electrically connecting the third electrode and the fourth electrode and magnetically coupled to the first transmission line, and a capacitor provided between the first electrode and the third electrode and/or between the second electrode and the fourth electrode.

### TECHNICAL FIELD

The present disclosure relates to an electronic component

### BACKGROUND

Japanese Unexamined Patent Publication No. 2009-44303 discloses an electronic component that includes a laminate made of a dielectric material, a set of input/output terminals, a detection terminal, and a termination terminal that are provided on a lower surface of the laminate, a main transmission line provided within the laminate and a sub transmission line that is coupled to the main transmission line, and a first attenuator and a second attenuator disposed on an upper surface of the laminate, in which respective ends of the main transmission line are connected to the input/output terminals, the sub transmission line has one end connected to the first attenuator and the other end connected to the second attenuator, the first attenuator is connected to the detection terminal via a first inductor provided inside the laminate, and the second attenuator is connected to the termination terminal via a second inductor provided inside the laminate.

### SUMMARY

When an electronic component becomes smaller in size, isolation thereof is deteriorated by formation of capacitance resulting from a reduced distance between the main transmission line and the sub transmission line provided in the base body (laminate), or by a reverse current due to a loop.

An objective of the present disclosure is to provide an electronic component capable of achieving improvement in isolation.

(1) An electronic component according to one aspect of the present disclosure includes a base body having a mounting surface and a main surface facing each other, a first electrode, a second electrode, a third electrode, and a fourth electrode disposed on the mounting surface, a first transmission line electrically connecting the first electrode and the second electrode, a second transmission line electrically connecting the third electrode and the fourth electrode and magnetically coupled to the first transmission line, and a capacitor provided between the first electrode and the third electrode and/or between the second electrode and the fourth electrode.

The electronic component according to one aspect of the present disclosure includes the capacitor provided between the first electrode and the third electrode and/or between the second electrode and the fourth electrode. As described above, in the electronic component, when a capacitance is formed by providing a capacitor between the first electrode and the third electrode and/or between the second electrode and the fourth electrode, a high level of isolation can be realized even when a distance between the first transmission line (main transmission line) and the second transmission line (sub transmission line) is small. Therefore, improvement in isolation can be achieved in the electronic component.

(2) In the electronic component of (1) described above, the capacitor may be constituted by a plurality of conductors disposed at the same height position in a facing direction between the mounting surface and the main surface. In this configuration, the capacitance of the capacitor can be easily adjusted. This configuration is particularly effective for forming a minute capacitance in the capacitor.

(3) In the electronic component of (2) described above, the plurality of conductors may include at least a first conductor, a second conductor, and a third conductor, and the second conductor may be disposed between the first conductor and the third conductor when viewed from the facing direction. In this configuration, the capacitance of the capacitor can be adjusted by adjusting the area over which adjacent conductors face each other.

(4) In the electronic component of any one of (1) to (3) described above, a first capacitor may be provided between the first electrode and the third electrode, a second capacitor may be provided between the second electrode and the fourth electrode, and a capacitance of the first capacitor may be different from a capacitance of the second capacitor. In this way, when two capacitors, the first capacitor and the second capacitor having different capacitances are provided as the capacitor, it is possible to easily adjust the capacitance of the capacitor in the electronic component.

(5) The electronic component of any one of (1) to (4) described above may include a ground electrode disposed on the mounting surface and connected to ground, and a resistor provided in an electrical path between the ground electrode and the second transmission line.

(6) In the electronic component of (5) described above, a first capacitor may be provided between the first electrode and the third electrode, a second capacitor may be provided between the second electrode and the fourth electrode, and the resistor may be disposed at a position closer to the plurality of conductors constituting the second capacitor than to the plurality of conductors constituting the first capacitor.

(7) The electronic component of any one of (1) to (6) described above may include a third capacitor and a fourth capacitor provided in an electrical path between the third electrode and the fourth electrode which include the second transmission line.

(8) The electronic component of (7) described above may include a first resistor electrically connected in series to the third capacitor, and a second resistor electrically connected in parallel to the fourth capacitor.

(9) In the electronic component of (7) or (8) described above, the capacitor may be constituted by a plurality of conductors disposed at the same height position in a facing direction between the mounting surface and the main surface, and an area of a region in which the plurality of conductors are disposed may be larger than an area of the conductors constituting each of the third capacitor and the fourth capacitor.

(10) In the electronic component of (2) described above, the plurality of conductors may be directly connected to any of the conductors connected in the facing direction between the mounting surface and the main surface in each of the first electrode, the second electrode, the third electrode, and the fourth electrode. In this configuration, loss can be reduced compared to a case in which a plurality of conductors are connected via another conductor (such as a bus bar).

According to the present disclosure, improvement in isolation can be achieved.

### BRIEF DESCRIPTION OF THE DRAWINGS

FIG. 1 is a perspective view illustrating an electronic component according to one embodiment.

FIGS. 2A, 2B, 2C, 2D, 2E, 2F, 2G, 2H, and 2I are views illustrating conductor layers.

FIG. 3 is a view illustrating conductor patterns included in a second conductor layer.

FIG. 4 is a view illustrating conductor patterns included in a fifth conductor layer.

FIG. 5 is a diagram showing an equivalent circuit of the electronic component illustrated in FIG. 1.

FIG. 6 is a view illustrating conductor patterns included in the electronic component illustrated in FIG. 1.

FIG. 7 is a graph showing a relationship between a frequency band and a coupling.

FIG. 8 is a graph showing a relationship between a frequency band and a directivity.

FIG. 9 is a view illustrating conductor patterns included in an electronic component according to another embodiment.

FIGS. 10A, 10B, 10C, 10D, 10E, 10F, 10G, 10H, and 10I are views illustrating conductor layers.

FIG. 11 is a view illustrating conductor patterns included in an electronic component according to yet another embodiment.

FIGS. 12A, 12B, 12C, 12D, 12E, 12F, 12G, 12H, and 12I are views illustrating conductor layers.

### DETAILED DESCRIPTION

Hereinafter, a preferred embodiment of the present disclosure will be described in detail with reference to the accompanying drawings. Also, in the description of the drawings, the same elements or elements having the same functions will be denoted by the same reference signs and duplicate descriptions thereof will be omitted.

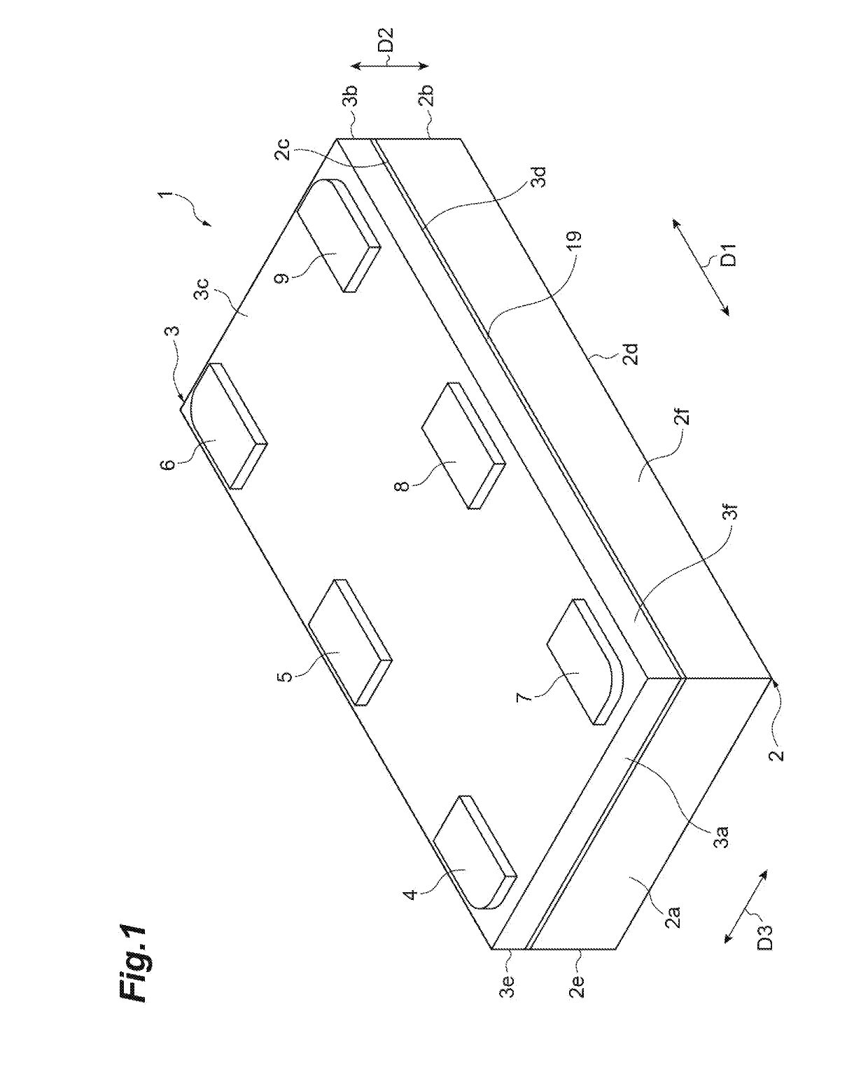

FIG. 1 is a perspective view illustrating an electronic component according to one embodiment. An electronic component 1 illustrated in FIG. 1 is, for example, a directional coupler. As illustrated in FIG. 1, the electronic component 1 includes a substrate 2, an insulator (base body) 3, and a first terminal electrode (first electrode) 4, a second terminal electrode (ground electrode) 5, a third terminal electrode (second electrode) 6, a fourth terminal electrode (third electrode) 7, a fifth terminal electrode 8, and a sixth terminal electrode (fourth electrode) 9 which are disposed on the insulator 3.

The substrate 2 has a rectangular parallelepiped shape. The rectangular parallelepiped shape includes a rectangular parallelepiped shape in which corner portions and edge line portions are chamfered, and a rectangular parallelepiped shape corner portions and edge line portions are rounded. The substrate 2 has, as outer surfaces thereof, a pair of end surfaces 2a and 2b facing each other, a pair of main surfaces 2c and 2d facing each other, and a pair of side surfaces 2e and 2f facing each other.

A direction in which the pair of end surfaces 2a and 2b face each other is defined as a first direction D1. A direction in which the pair of main surfaces 2c and 2d face each other is defined as a second direction D2. A direction in which the pair of side surfaces 2e and 2f face each other is defined as a third direction D3. In the present embodiment, the first direction D1 is a longitudinal direction of the substrate 2. The second direction D2 is a height direction of the substrate 2 and is orthogonal to the first direction D1. The third direction D3 is a width direction of the substrate 2 and is orthogonal to the first direction D1 and the second direction D2.

The pair of end surfaces 2a and 2b extend in the second direction D2 so that the pair of main surfaces 2c and 2d are connected. The pair of end surfaces 2a and 2b also extend in the third direction D3. The pair of side surfaces 2e and 2f extend in the second direction D2 so that the pair of main surfaces 2c and 2d are connected. The pair of side surfaces 2e and 2f also extend in the first direction D1.

The substrate 2 is formed of a material that is chemically and thermally stable, thereby causing less stress, and is capable of maintaining surface smoothness. The material is not particularly limited, and silicon single crystal, alumina, sapphire, aluminum nitride, MgO single crystal, SrTiO₃ single crystal, surface-oxidized silicon, glass, quartz, ferrite, or the like can be used.

The insulator 3 has a rectangular parallelepiped shape. The insulator 3 has, as outer surfaces thereof, a pair of end surfaces 3a and 3b facing each other, a pair of main surfaces 3c and 3d facing each other, and a pair of side surfaces 3e and 3f facing each other. The pair of end surfaces 3a and 3b face each other in the first direction D1. The pair of main surfaces 3c and 3d face each other in the second direction D2. The pair of side surfaces 3e and 3f face each other in the third direction D3. In the electronic component 1, the main surface 3c constitutes a mounting surface that faces an electronic device or the like.

The pair of end surfaces 3a and 3b extend in the second direction D2 so that the pair of main surfaces 3c and 3d are connected. The pair of end surfaces 3a and 3b also extend in the third direction D3. The pair of side surfaces 3e and 3f extend in the second direction D2 so that the pair of main surfaces 3c and 3d are connected. The pair of side surfaces 3e and 3f also extend in the first direction D1. A dimension of the insulator 3 in the first direction D1 is equivalent to a dimension of the substrate 2 in the first direction D1. A dimension of the insulator 3 in the third direction D3 is equivalent to a dimension of the substrate 2 in the third direction D3.

Further, in the present embodiment, the term “equivalent” may also refer to values including slight differences, manufacturing errors, or the like within a preset range, in addition to being equivalent. For example, when a plurality of values fall within a range of ±5% of an average value of the plurality of values, the plurality of values are defined as being equivalent.

The insulator 3 is configured by laminating a plurality of insulating layers (not illustrated). The insulator layers are formed of an organic insulating material such as polyimide. The insulator layers are laminated in the second direction D2. That is, the second direction D2 is a lamination direction. In the actual insulator 3, the plurality of insulator layers are integrated to such an extent that boundaries between layers are not visible.

The substrate 2 and the insulator 3 are provided integrally. The substrate 2 and the insulator 3 are disposed such that the main surface 2c and the main surface 3d face each other. A planarization layer 19 is disposed between the substrate 2 and the insulator 3. The planarization layer 19 is disposed between the main surface 2c of the substrate 2 and the main surface 3d of the insulator 3. As the planarization layer 19, alumina, silicon oxide, or the like can be used.

The first terminal electrode 4, the second terminal electrode 5, the third terminal electrode 6, the fourth terminal electrode 7, the fifth terminal electrode 8, and the sixth terminal electrode 9 are disposed on the main surface 3c of the insulator 3. In the present embodiment, the first terminal electrode 4 serves as a coupling terminal (detection electrode). The second terminal electrode 5 and The fifth terminal electrode 8 serves as a ground terminal. The third terminal electrode 6 serves as termination terminals. The fourth terminal electrode 7 serves as an input terminal. The sixth terminal electrode 9 serve as an output terminal.

The first terminal electrode 4, the second terminal electrode 5, the third terminal electrode 6, the fourth terminal electrode 7, the fifth terminal electrode 8, and the sixth terminal electrode 9 have a substantially rectangular shape in a plan view. The rectangular shape includes a shape in which corner portions and edge line portions are chamfered, and a shape in which the corner portions and edge line portions are rounded. The first terminal electrode 4, the third terminal electrode 6, the fourth terminal electrode 7, and the sixth terminal electrode 9 each have a shape in which one corner portion is rounded (curved).

The first terminal electrode 4 is disposed at a position close to the end surface 3a and close to the side surface 3e. The second terminal electrode 5 is disposed at a position between the end surface 3a and the end surface 3b and close to the side surface 3e. The third terminal electrode 6 is disposed at a position close to the end surface 3b and close to the side surface 3e. The fourth terminal electrode 7 is disposed at a position close to the end surface 3a and close to the side surface 3f. The fifth terminal electrode 8 is disposed at a position between the end surface 3a and the end surface 3b and close to the side surface 3f. The sixth terminal electrode 9 is disposed at a position close to the end surface 3b and close to the side surface 3f.

The first terminal electrode 4, the second terminal electrode 5, and the third terminal electrode 6 are disposed at intervals in the first direction D1. The fourth terminal electrode 7, the fifth terminal electrode 8, and the sixth terminal electrode 9 are disposed at intervals in the first direction D1. The first terminal electrode 4 and the fourth terminal electrode 7 are disposed at an interval in the third direction D3. The second terminal electrode 5 and the fifth terminal electrode 8 are disposed at an interval in the third direction D3. The third terminal electrode 6 and the sixth terminal electrode 9 are disposed at an interval in the third direction D3. A distance between the terminal electrodes may be appropriately selected according to specifications required for the electronic component 1.

The first terminal electrode 4, the second terminal electrode 5, the third terminal electrode 6, the fourth terminal electrode 7, the fifth terminal electrode 8, and the sixth terminal electrode 9 may be formed of a suitable conductor (for example, gold, nickel, copper, silver, and the like).

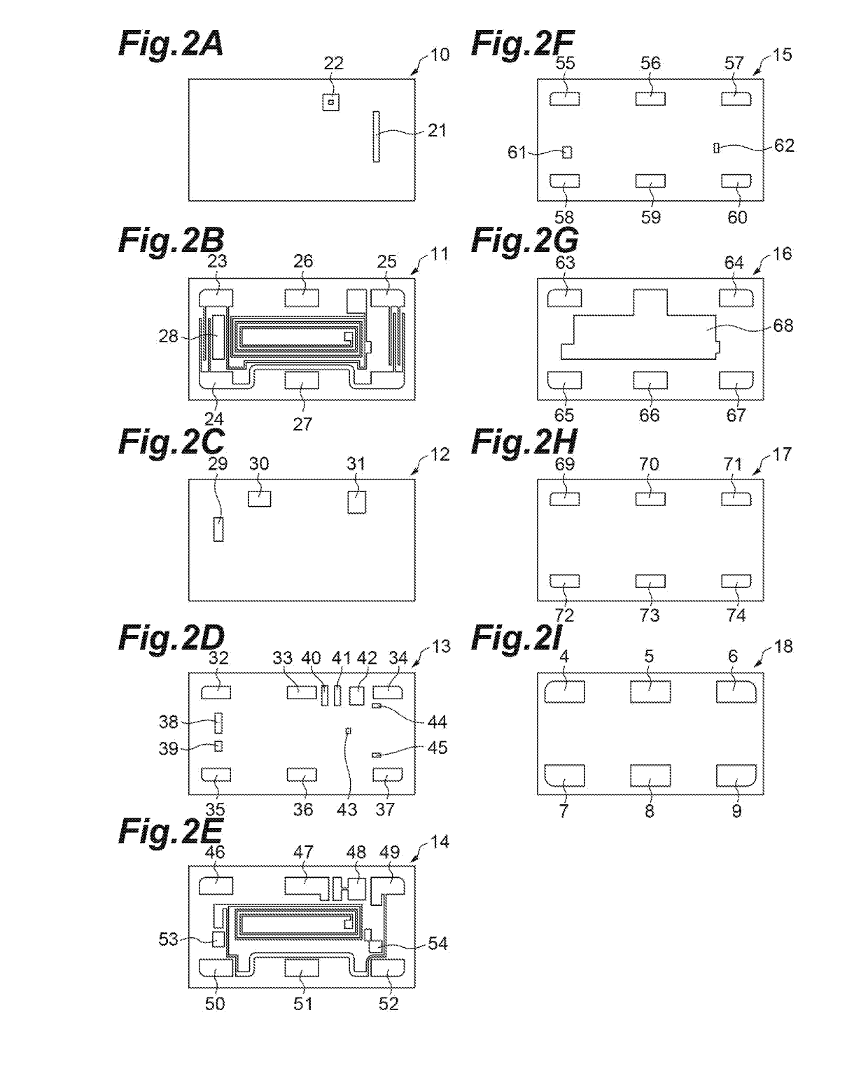

FIGS. 2A, 2B, 2C, 2D, 2E, 2F, 2G, 2H, and 2I are views illustrating conductor layers. FIGS. 2A, 2B, 2C, 2D, 2E, 2F, 2G, 2H, and 2I are views of conductor patterns viewed from the second direction D2.

As illustrated in FIGS. 2A, 2B, 2C, 2D, 2E, 2F, 2G, 2H, and 2I, the electronic component 1 includes a first conductor layer 10, a second conductor layer 11, a third conductor layer 12, a fourth conductor layer 13, a fifth conductor layer 14, a sixth conductor layer 15, a seventh conductor layer 16, an eighth conductor layer 17, and a terminal layer 18. The first conductor layer 10, the second conductor layer 11, the third conductor layer 12, the fourth conductor layer 13, the fifth conductor layer 14, the sixth conductor layer 15, the seventh conductor layer 16, the eighth conductor layer 17, and the terminal layer 18 are disposed in different layers from one another in the second direction D2.

As illustrated in FIG. 2A, the first conductor layer 10 includes a resistor pattern 21 and a resistor pattern 22. The resistor pattern 21 and the resistor pattern 22 can be formed of a suitable conductor (for example, nickel, chromium, aluminum, or the like).

As illustrated in FIG. 2B, the second conductor layer 11 includes a conductor pattern 23, a conductor pattern 24, a conductor pattern 25, a conductor pattern 26, and a conductor pattern 27. The conductor pattern 23, the conductor pattern 24, the conductor pattern 25, the conductor pattern 26, and the conductor pattern 27 can be formed of a suitable conductor (for example, copper).

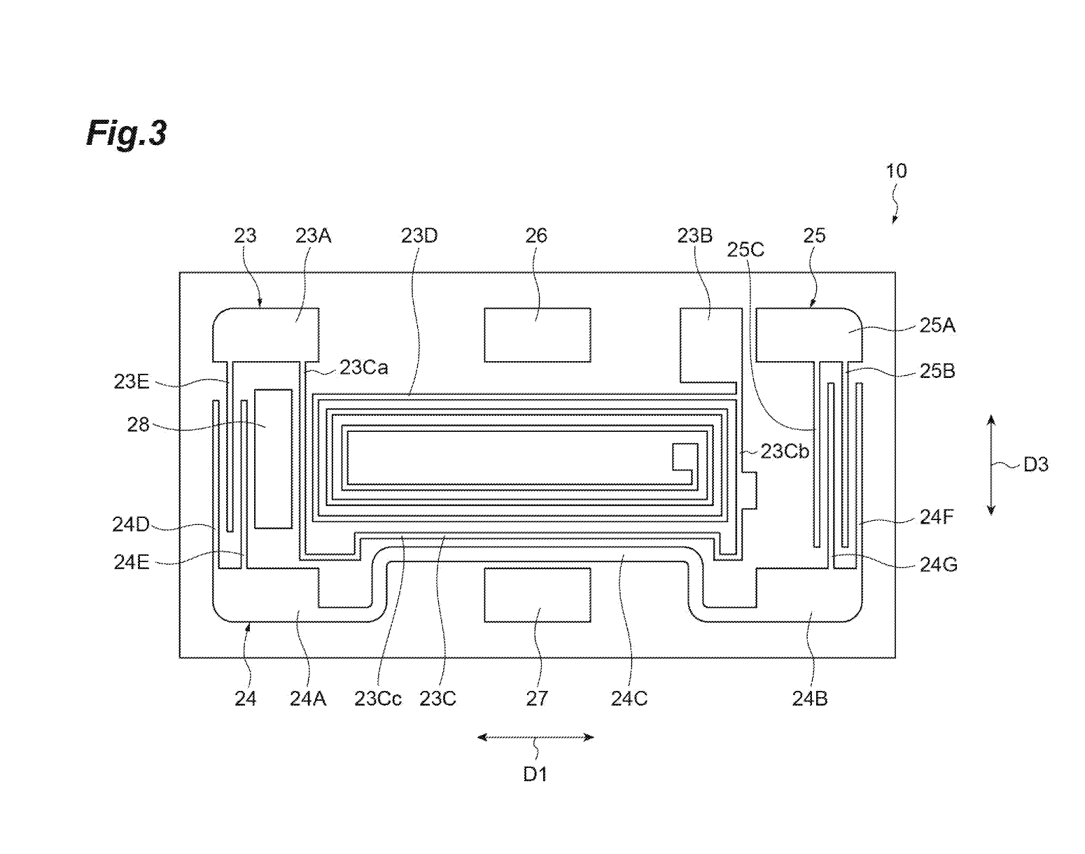

FIG. 3 is a view illustrating conductor patterns included in the second conductor layer 11. As illustrated in FIG. 2B and FIG. 3, the conductor pattern 23 has a first pattern portion 23A, a second pattern portion 23B, a third pattern portion 23C, a fourth pattern portion 23D, and a fifth pattern portion 23E.

The first pattern portion 23A is disposed at a position close to the end surface 3a and close to the side surface 3e. The second pattern portion 23B is disposed at a position close to the side surface 3e between the conductor pattern 25 (first pattern portion 25A) and the conductor pattern 26 in the first direction D1. The second pattern portion 23B has a rectangular shape.

The third pattern portion 23C electrically connects the first pattern portion 23A and the second pattern portion 23B. The third pattern portion 23C has a first portion 23Ca, a second portion 23Cb, and a third portion 23Cc. The first portion 23Ca extends in the third direction D3. One end of the first portion 23Ca (an end on the side surface 3e side) is connected to the first pattern portion 23A. The other end of the first portion 23Ca (an end on the side surface 3f side) is connected to one end of the third portion 23Cc (an end on the end surface 3a side).

The second portion 23Cb extends in the third direction D3. One end of the second portion 23Cb (an end on the side surface 3e side) is connected to the second pattern portion 23B. The other end of the second portion 23Cb (an end on the side surface 3f side) is connected to the other end of the third portion 23Cc (an end on the end surface 3b side). The third portion 23Cc connects the first portion 23Ca and the second portion 23Cb. The third portion 23Cc has a portion extending in the first direction D1. The third portion 23Cc is disposed to be aligned with (in close proximity to) a third pattern portion 24C (to be described later) of the conductor pattern 24 in the third direction D3.

The fourth pattern portion 23D has a spiral shape. One end of the fourth pattern portion 23D is connected to the third pattern portion 23C (the second portion 23Cb). The fifth pattern portion 23E extends in the third direction D3. One end of the fifth pattern portion 23E (an end on the side surface 3e side) is connected to the first pattern portion 23A. The fifth pattern portion 23E is directly connected to the first pattern portion 23A. That is, the fifth pattern portion 23E is connected to the first pattern portion 23A without any other member (such as a bus bar pattern) interposed.

The conductor pattern 24 has a first pattern portion 24A, a second pattern portion 24B, the third pattern portion 24C, a fourth pattern portion 24D, a fifth pattern portion 24E, a sixth pattern portion 24F, and a seventh pattern portion 24G.

The first pattern portion 24A is disposed at a position close to the end surface 3a and close to the side surface 3f. The second pattern portion 24B is disposed at a position close to the end surface 3b and close to the side surface 3f. The third pattern portion 24C connects the first pattern portion 24A and the second pattern portion 24B. The third pattern portion 24C has a portion extending in the first direction D1. That portion of the third pattern portion 24C described above extends parallel to the third portion 23Cc of the third pattern portion 23C of the conductor pattern 23.

The fourth pattern portion 24D extends in the third direction D3. One end of the fourth pattern portion 24D (an end on the side surface 3f side) is connected to the first pattern portion 24A. The fourth pattern portion 24D is directly connected to the first pattern portion 24A. That is, the fourth pattern portion 24D is connected to the first pattern portion 24A without any other member (such as a bus bar pattern) interposed. The fifth pattern portion 24E extends in the third direction D3. One end of the fifth pattern portion 24E (an end on the side surface 3f side) is connected to the first pattern portion 24A. The fifth pattern portion 24E is directly connected to the first pattern portion 24A. That is, the fifth pattern portion 24E is connected to the first pattern portion 24A without any other member (such as a bus bar pattern) interposed. The fourth pattern portion 24D and the fifth pattern portion 24E are disposed at an interval in the first direction D1. The fourth pattern portion 24D and the fifth pattern portion 24E are equivalent in length in the third direction D3.

The fifth pattern portion 23E of the conductor pattern 23 is positioned between the fourth pattern portion 24D and the fifth pattern portion 24E of the conductor pattern 24. That is, the fifth pattern portion 23E is disposed at a position sandwiched between the fourth pattern portion 24D and the fifth pattern portion 24E. The fourth pattern portion 24D, the fifth pattern portion 23E, and the fifth pattern portion 24E are disposed in that order in the first direction D1 from the end surface 3a side of the insulator 3.

A part of the fifth pattern portion 23E overlaps respective parts of the fourth pattern portion 24D and the fifth pattern portion 24E when viewed from the first direction D1. In the present embodiment, a distance in the first direction D1 between the fifth pattern portion 23E and the fourth pattern portion 24D is equal to a distance in the first direction D1 between the fifth pattern portion 23E and the fifth pattern portion 24E. In the present embodiment, widths (widths in the first direction D1) of the fifth pattern portion 23E, the fourth pattern portion 24D, and the fifth pattern portion 24E are equal.

The sixth pattern portion 24F extends in the third direction D3. One end of the sixth pattern portion 24F (an end on the side surface 3f side) is connected to the second pattern portion 24B. The sixth pattern portion 24F is directly connected to the second pattern portion 24B. That is, the sixth pattern portion 24F is connected to the second pattern portion 24B without any other member (such as a bus bar pattern) interposed. The seventh pattern portion 24G extends in the third direction D3. One end of the seventh pattern portion 24G (an end on the side surface 3f side) is connected to the second pattern portion 24B. The seventh pattern portion 24G is directly connected to the second pattern portion 24B. That is, the seventh pattern portion 24G is connected to the second pattern portion 24B without any other member (such as a bus bar pattern) interposed. The sixth pattern portion 24F and the seventh pattern portion 24G are disposed at an interval in the first direction D1. The sixth pattern portion 24F and the seventh pattern portion 24G are equivalent in length in the third direction D3.

The conductor pattern 25 has a first pattern portion 25A, a second pattern portion 25B, and a third pattern portion 25C. The first pattern portion 25A is disposed at a position close to the end surface 3b and close to the side surface 3e.

The second pattern portion 25B extends in the third direction D3. One end of the second pattern portion 25B (an end on the side surface 3e side) is connected to the first pattern portion 25A. The second pattern portion 25B is directly connected to the first pattern portion 25A. That is, the second pattern portion 25B is connected to the first pattern portion 25A without any other member (such as a bus bar pattern) interposed. The third pattern portion 25C extends in the third direction D3. One end of the third pattern portion 25C (an end on the side surface 3e side) is connected to the first pattern portion 25A. The third pattern portion 25C is directly connected to the first pattern portion 25A. That is, the third pattern portion 25C is connected to the first pattern portion 25A without any other member (such as a bus bar pattern) interposed.

The seventh pattern portion 24G of the conductor pattern 24 is positioned between the second pattern portion 25B and the third pattern portion 25C of the conductor pattern 25. That is, the seventh pattern portion 24G is disposed at a position sandwiched between the second pattern portion 25B and the third pattern portion 25C. The second pattern portion 25B of the conductor pattern 25 is disposed between the sixth pattern portion 24F and the seventh pattern portion 24G of the conductor pattern 24. That is, the second pattern portion 25B is disposed at a position sandwiched between the sixth pattern portion 24F and the seventh pattern portion 24G. The sixth pattern portion 24F, the second pattern portion 25B, the seventh pattern portion 24G, and the third pattern portion 25C are disposed in that order in the first direction D1 from the end surface 3b side of the insulator 3.

Parts of the sixth pattern portion 24F, the seventh pattern portion 24G, the second pattern portion 25B, and the third pattern portion 25C overlap when viewed from the first direction D1. In the present embodiment, a distance in the first direction D1 between the sixth pattern portion 24F and the second pattern portion 25B, a distance in the first direction D1 between the second pattern portion 25B and the seventh pattern portion 24G, and a distance in the first direction D1 between the seventh pattern portion 24G and the third pattern portion 25C are equivalent. In the present embodiment, widths (widths in the first direction D1) of the sixth pattern portion 24F, the seventh pattern portion 24G, the second pattern portion 25B, and the third pattern portion 25C are equivalent.

The conductor pattern 26 is disposed at a central position in the first direction D1 and at a position close to the side surface 3e. The conductor pattern 27 is disposed at a central position in the first direction D1 and at a position close to the side surface 3f. The conductor pattern 28 is disposed in a region formed (surrounded) by the first pattern portion 23A and the third pattern portion 23C (the first portion 23Ca) of the conductor pattern 23, and the first pattern portion 24A and the fifth pattern portion 24E of the conductor pattern 24. The conductor pattern 28 has a rectangular shape. The conductor pattern 28 extends in the third direction D3.

As illustrated in FIG. 2C, the third conductor layer 12 includes a capacitor pattern 29, a capacitor pattern 30, and a capacitor pattern 31. The capacitor pattern 29 is disposed at a position facing the conductor pattern 28 of the second conductor layer 11 in the second direction D2. The capacitor pattern 31 is disposed at a position facing the second pattern portion 23B of the conductor pattern 23 of the second conductor layer 11.

As illustrated in FIG. 2D, the fourth conductor layer 13 has a via conductor 32, a via conductor 33, a via conductor 34, a via conductor 35, a via conductor 36, a via conductor 37, a via conductor 38, a via conductor 39, a via conductor 40, a via conductor 41, a via conductor 42, a via conductor 43, a via conductor 44, and a via conductor 45.

The via conductor 32 electrically connects the first pattern portion 23A of the conductor pattern 23 of the second conductor layer 11 and a conductor pattern 46 (to be described later) of the fifth conductor layer 14. The via conductor 33 electrically connects the conductor pattern 26 of the second conductor layer 11 and a conductor pattern 47 (to be described later) of the fifth conductor layer 14. The via conductor 34 electrically connects the first pattern portion 25A of the conductor pattern 25 of the second conductor layer 11 and the conductor pattern 49 (to be described later) of the fifth conductor layer 14.

The via conductor 35 electrically connects the first pattern portion 24A of the conductor pattern 24 of the second conductor layer 11 and a conductor pattern 50 (to be described later) of the fifth conductor layer 14. The via conductor 36 electrically connects the conductor pattern 27 of the second conductor layer 11 and a conductor pattern 51 (to be described later) of the fifth conductor layer 14. The via conductor 37 electrically connects the second pattern portion 24B of the conductor pattern 24 of the second conductor layer 11 and a conductor pattern 52 (to be described later) of the fifth conductor layer 14.

The via conductor 38 electrically connects the capacitor pattern 29 of the third conductor layer 12 and a conductor pattern 49 (to be described later) of the fifth conductor layer 14. The via conductor 39 electrically connects the conductor pattern 28 of the second conductor layer 11 and a conductor pattern 53 (to be described later) of the fifth conductor layer 14. The via conductor 40 electrically connects the resistor pattern 22 of the first conductor layer 10 and the conductor pattern 47 (to be described later) of the fifth conductor layer 14. The via conductor 41 electrically connects the resistor pattern 22 of the first conductor layer 10 and a conductor pattern 48 (to be described later) of the fifth conductor layer 14.

The via conductor 42 electrically connects the second pattern portion 23B of the conductor pattern 23 of the second conductor layer 11 and the conductor pattern 48 (to be described later) of the fifth conductor layer 14. The via conductor 43 electrically connects the fourth pattern portion 23D of the conductor pattern 23 of the second conductor layer 11 and the conductor pattern 49 (to be described later) of the fifth conductor layer 14. The via conductor 44 electrically connects the resistor pattern 21 of the first conductor layer 10 and the conductor pattern 49 (to be described later) of the fifth conductor layer 14. The via conductor 45 electrically connects the resistor pattern 21 of the first conductor layer 10 and a conductor pattern 54 (to be described later) of the fifth conductor layer 14.

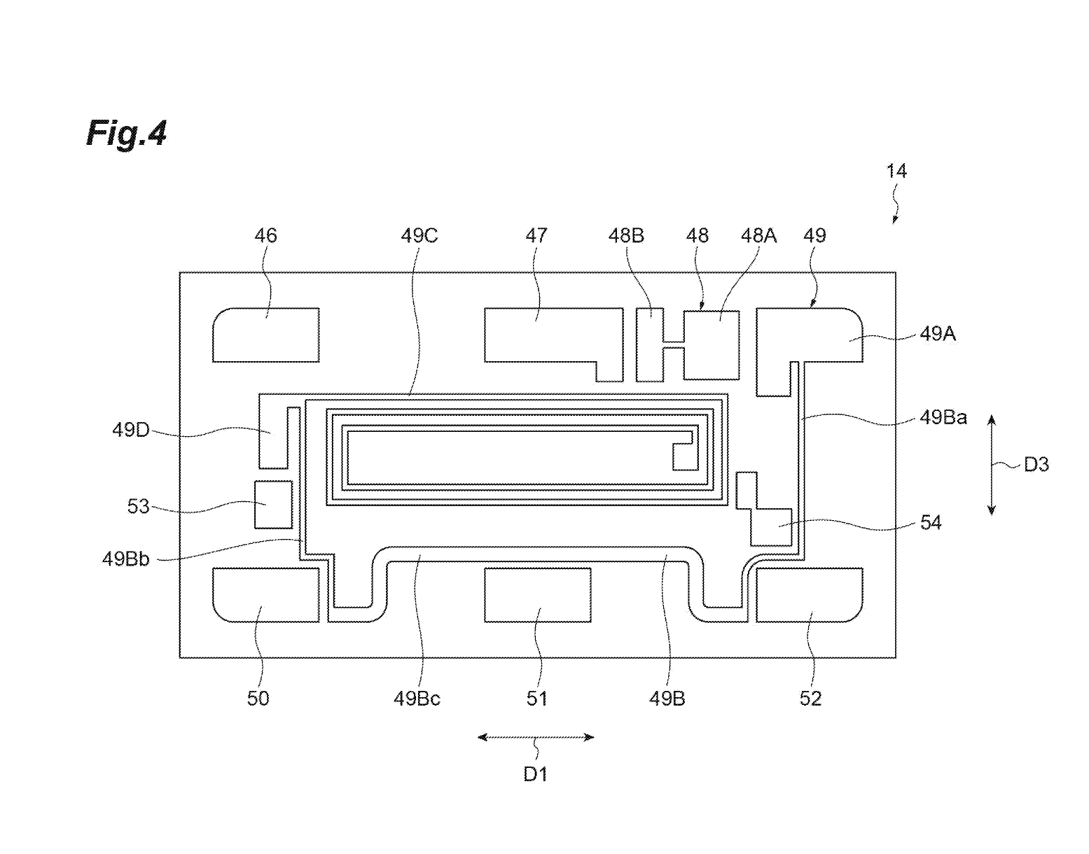

FIG. 4 is a view illustrating conductor patterns included in the fifth conductor layer 14. As illustrated in FIGS. 2E and 4, the fifth conductor layer 14 includes the conductor pattern 46, the conductor pattern 47, the conductor pattern 48, the conductor pattern 49, the conductor pattern 50, the conductor pattern 51, and the conductor pattern 52.

The conductor pattern 46 is disposed at a position close to the end surface 3a and close to the side surface 3e. The conductor pattern 47 is disposed at a central position in the first direction D1 and at a position close to the side surface 3e. The conductor pattern 48 is disposed between the conductor pattern 47 and the conductor pattern 49 in the first direction D1. The conductor pattern 48 includes a first pattern portion 48A and a second pattern portion 48B.

The conductor pattern 49 has a first pattern portion 49A, a second pattern portion 49B, a third pattern portion 49C, and a fourth pattern portion 49D. The first pattern portion 49A is disposed at a position close to the end surface 3b and close to the side surface 3e.

The second pattern portion 49B has a first portion 49Ba, a second portion 49Bb, and a third portion 49Bc. The first portion 49Ba extends in the third direction D3. One end of the first portion 49Ba (an end on the side surface 3e side) is connected to the first pattern portion 49A. The other end of the first portion 49Ba (an end on the side surface 3f side) is connected to the third portion 49Bc. The second portion 49Bb extends in the third direction D3. One end of the second portion 49Bb (an end on the side surface 3e side) is connected to the third pattern portion 49C. The other end of the second portion 49Bb (an end on the side surface 3f side) is connected to the third portion 49Bc. The third portion 49Bc connects the first portion 49Ba and the second portion 49Bb. The third portion 49Bc has a portion extending in the first direction D1. The third portion 49Bc is disposed at a position facing the third pattern portion 24C of the conductor pattern 24 of the second conductor layer 11 in the second direction D2.

The third pattern portion 49C has a spiral shape. One end of the third pattern portion 49C is connected to the second pattern portion 49B (the second portion 49Bb). The fourth pattern portion 49D is connected to the second pattern portion 49B (the second portion 49Bb).

The conductor pattern 50 is disposed at a position close to the end surface 3a and close to the side surface 3f. The conductor pattern 51 is disposed at a central position in the first direction D1 and at a position close to the side surface 3f. The conductor pattern 52 is disposed at a position close to the end surface 3b and close to the side surface 3f. The conductor pattern 53 is disposed at a position close to the end surface 3a. The conductor pattern 54 is disposed at a position close to the end surface 3b.

As illustrated in FIG. 2F, the sixth conductor layer 15 has a via conductor 55, a via conductor 56, a via conductor 57, a via conductor 58, a via conductor 59, a via conductor 60, a via conductor 61, and a via conductor 62.

The via conductor 55 electrically connects the conductor pattern 46 of the fifth conductor layer 14 and a conductor pattern 63 (to be described later) of the seventh conductor layer 16. The via conductor 56 electrically connects the conductor pattern 47 of the fifth conductor layer 14 and a ground pattern 68 (to be described later) of the seventh conductor layer 16. The via conductor 57 electrically connects the conductor pattern 49 of the fifth conductor layer 14 and a conductor pattern 64 (to be described later) of the seventh conductor layer 16.

The via conductor 58 electrically connects the conductor pattern 50 of the fifth conductor layer 14 and a conductor pattern 65 (to be described later) of the seventh conductor layer 16. The via conductor 59 electrically connects the conductor pattern 51 of the fifth conductor layer 14 and a conductor pattern 66 (to be described later) of the seventh conductor layer 16. The via conductor 60 electrically connects the conductor pattern 52 of the fifth conductor layer 14 and a conductor pattern 67 (to be described later) of the seventh conductor layer 16. The via conductor 61 electrically connects the conductor pattern 53 of the fifth conductor layer 14 and the ground pattern 68 (to be described later) of the seventh conductor layer 16. The via conductor 62 electrically connects the conductor pattern 54 of the fifth conductor layer 14 and the ground pattern 68 (to be described later) of the seventh conductor layer 16.

As illustrated in FIG. 2G, the seventh conductor layer 16 includes the conductor pattern 63, the conductor pattern 64, the conductor pattern 65, the conductor pattern 66, the conductor pattern 67, and the ground pattern 68.

The conductor pattern 63 is disposed at a position close to the end surface 3a and close to the side surface 3e. The conductor pattern 64 is disposed at a position close to the end surface 3b and close to the side surface 3e. The conductor pattern 65 is disposed at a position close to the end surface 3a and close to the side surface 3f. The conductor pattern 66 is disposed at a central position in the first direction D1 and at a position close to the side surface 3f. The conductor pattern 67 is disposed at a position close to the end surface 3b and close to the side surface 3f.

As illustrated in FIG. 2H, the eighth conductor layer 17 has a via conductor 69, a via conductor 70, a via conductor 71, a via conductor 72, a via conductor 73, and a via conductor 74.

The via conductor 69 electrically connects the conductor pattern 63 of the seventh conductor layer 16 and the first terminal electrode 4 of the terminal layer 18. The via conductor 70 electrically connects the ground pattern 68 of the seventh conductor layer 16 and the second terminal electrode 5 of the terminal layer 18. The via conductor 71 electrically connects the conductor pattern 64 of the seventh conductor layer 16 and the third terminal electrode 6 of the terminal layer 18.

The via conductor 72 electrically connects the conductor pattern 65 of the seventh conductor layer 16 and the fourth terminal electrode 7 of the terminal layer 18. The via conductor 73 electrically connects the conductor pattern 66 of the seventh conductor layer 16 and the fifth terminal electrode 8 of the terminal layer 18. The via conductor 74 electrically connects the conductor pattern 67 of the seventh conductor layer 16 and the sixth terminal electrode 9 of the terminal layer 18.

As illustrated in FIG. 2I, the terminal layer 18 includes the first terminal electrode 4, the second terminal electrode 5, the third terminal electrode 6, the fourth terminal electrode 7, the fifth terminal electrode 8, and the sixth terminal electrode 9.

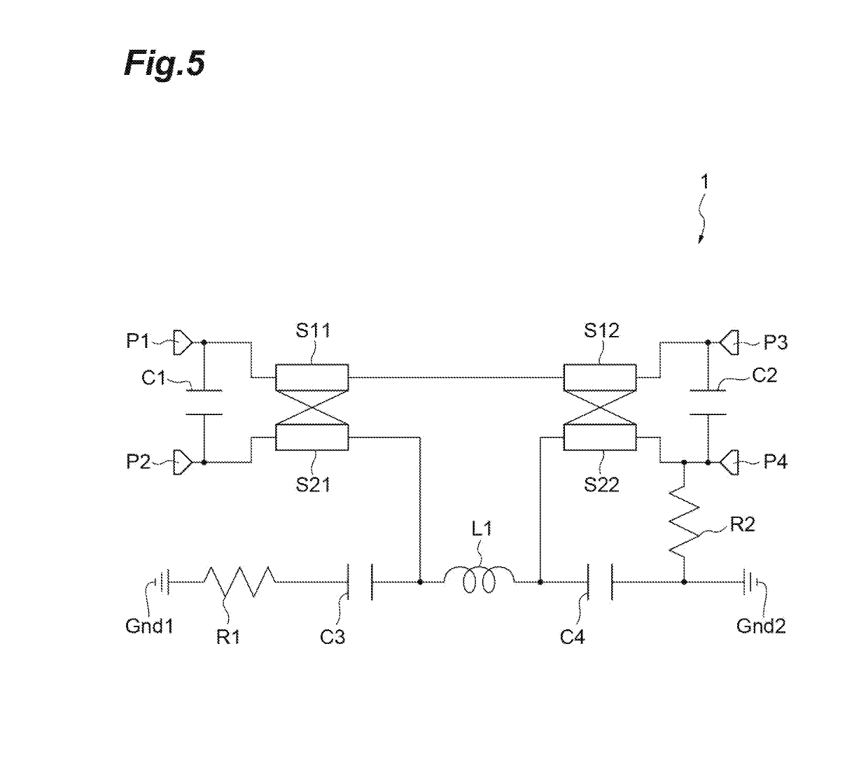

FIG. 5 is a diagram showing an equivalent circuit of the electronic component 1. As illustrated in FIG. 5, the electronic component 1 includes a first port P1, a second port P2, a third port P3, a fourth port P4, a ground Gnd1, a ground Gnd2, a first transmission line S11, a second transmission line S12, a first transmission line S21, a second transmission line S22, an inductor L1, a capacitor (first capacitor) C1, a capacitor (second capacitor) C2, a capacitor (third capacitor) C3, a capacitor (fourth capacitor) C4, a resistor (first resistor) R1, and a resistor (second resistor) R2.

The first port P1 is an input port. The first port P1 is constituted by the fourth terminal electrode 7. The second port P2 is a coupling port. The second port P2 is constituted by the first terminal electrode 3. The third port P3 is a termination port. The third port P3 is constituted by the third terminal electrode 6. The fourth port P4 is an output port. The fourth port P4 is constituted by the sixth terminal electrode 9. The ground Gnd1 and the ground Gnd2 are constituted by the second terminal electrode 5 and the fifth terminal electrode 8.

The first transmission line S11 and the second transmission line S12 are constituted by the third pattern portion 23C (third portion 23Cc) of the conductor pattern 23. The second transmission line S21 is constituted by the third pattern portion 24C of the conductor pattern 24. The second transmission line S22 is constituted by the second pattern portion 49B (third portion 49Bc) of the conductor pattern 49. The first transmission line S11 and the first transmission line S21 are magnetically coupled. The second transmission line S12 and the second transmission line S22 are magnetically coupled.

The inductor L1 is constituted by the fourth pattern portion 23D of the conductor pattern 23 and the third pattern portion 49C of the conductor pattern 49.

The capacitor C1 is connected between the first port P1 and the second port P2. The capacitor C1 is constituted by the fifth pattern portion 23E of the conductor pattern 23 of the second conductor layer 11, and the fourth pattern portion 24D and fifth pattern portion 24E of the conductor pattern 24 of the second conductor layer 11. That is, the capacitor C1 is constituted by the plurality of conductors disposed in the same layer (at the same height position).

The capacitor C2 is connected between the third port P3 and the fourth port P4. The capacitor C2 is constituted by the sixth pattern portion 24F and seventh pattern portion 24G of the conductor pattern 24 of the second conductor layer 11, and the second pattern portion 25B and third pattern portion 25C of the conductor pattern 25 of the second conductor layer 11. That is, the capacitor C2 is constituted by the plurality of conductors disposed in the same layer (at the same height position).

A capacitance of the capacitor C1 is different from that of the capacitor C2. In the present embodiment, the capacitance of the capacitor C1 is smaller than that of the capacitor C2. In other words, the capacitance of the capacitor C2 is larger than that of the capacitor C1. The capacitance of the capacitor C1 is, for example, 0. 06 pF. The capacitance of the capacitor C2 is, for example, 0. 09 pF.

As illustrated in FIG. 3, an area of the fifth pattern portion 23E, the fourth pattern portion 24D, and the fifth pattern portion 24E which constitute the capacitor C1 is smaller than an area of the sixth pattern portion 24F, the seventh pattern portion 24G, the second pattern portion 25B, and the third pattern portion 25C which constitute the capacitor C2. In other words, the area of the sixth pattern portion 24F, the seventh pattern portion 24G, the second pattern portion 25B, and the third pattern portion 25C which constitute the capacitor C2 is larger than the area of the fifth pattern portion 23E, the fourth pattern portion 24D, and the fifth pattern portion 24E which constitute the capacitor C1.

The capacitor C3 is constituted by the conductor pattern 28 and the capacitor pattern 29. The capacitor C4 is constituted by the second pattern portion 23B of the conductor pattern 23 and the capacitor pattern 31.

The resistor R1 is constituted by the resistor pattern 22. The resistor R2 is constituted by the resistor pattern 21.

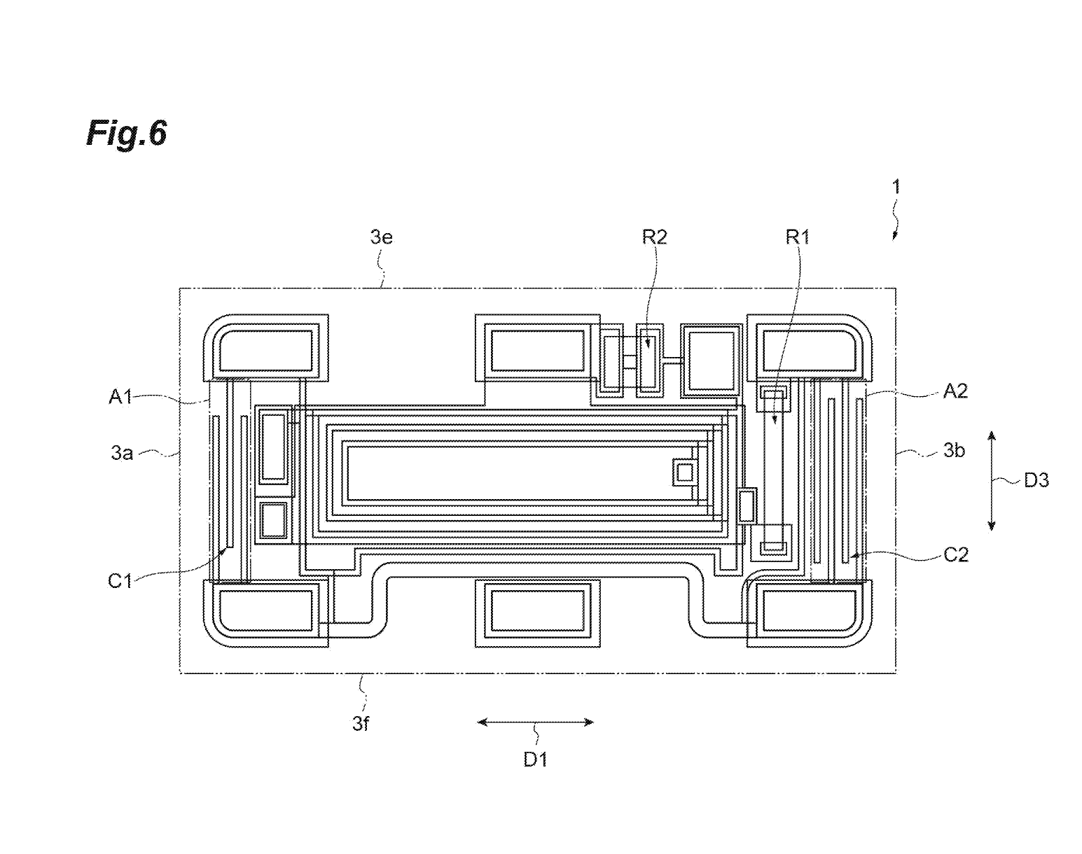

FIG. 6 is a view illustrating the conductor patterns included in the electronic component 1 illustrated in FIG. 1. In FIG. 6, the conductor patterns are shown overlaid. As illustrated in FIG. 6, the resistor R1 (resistor pattern 21) and the resistor R2 (resistor pattern 22) are disposed at a position closer to the sixth pattern portion 24F, the seventh pattern portion 24G, the second pattern portion 25B, and the third pattern portion 25C, which constitute the capacitor C2, than to the fifth pattern portion 23E, the fourth pattern portion 24D, and the fifth pattern portion 24E, which constitute the capacitor C1. It can also be said that shortest distances from each of the resistor patterns 21 and 22 to the sixth pattern portion 24F, the seventh pattern portion 24G, the second pattern portion 25B, and the third pattern portion 25C are larger than shortest distances from each of the resistor patterns 21 and 22 to the fifth pattern portion 23E, the fourth pattern portion 24D, and the fifth pattern portion 24E.

An area of a region A1 in which the capacitor C1 is disposed is larger than an area of the conductor pattern 28 and the capacitor pattern 29, which constitute the capacitor C3, and an area of the second pattern portion 23B of the conductor pattern 23 and the capacitor pattern 31, which constitute the capacitor C4. An area of a region A2 in which the capacitor C2 is disposed is larger than the area of the conductor pattern 28 and the capacitor pattern 29, which constitute the capacitor C3, and the area of the second pattern portion 23B of the conductor pattern 23 and the capacitor pattern 31, which constitute the capacitor C4.

As illustrated in FIG. 5, the capacitor C3 and the resistor R1 are electrically connected in series. The capacitor C4 and the resistor R2 are electrically connected in parallel. The resistor R1, the capacitor C3, the inductor L1, and the capacitor C4 are electrically connected in series.

As described above, in the electronic component 1 according to the present embodiment, the capacitor C1 is provided between the first terminal electrode 4 and the fourth terminal electrode 7, and the capacitor C2 is provided between the third terminal electrode 6 and the sixth terminal electrode 9. As described above, in the electronic component 1, when a capacitance is formed by providing the capacitor C1 between the first terminal electrode 4 and the fourth terminal electrode 7 and providing the capacitor C2 between the third terminal electrode 6 and the sixth terminal electrode 9, a high level of isolation can be realized even when a distance between the first transmission lines S11 and S12 and the second transmission lines S21 and S22 is small. Therefore, improved isolation can be achieved in the electronic component 1.

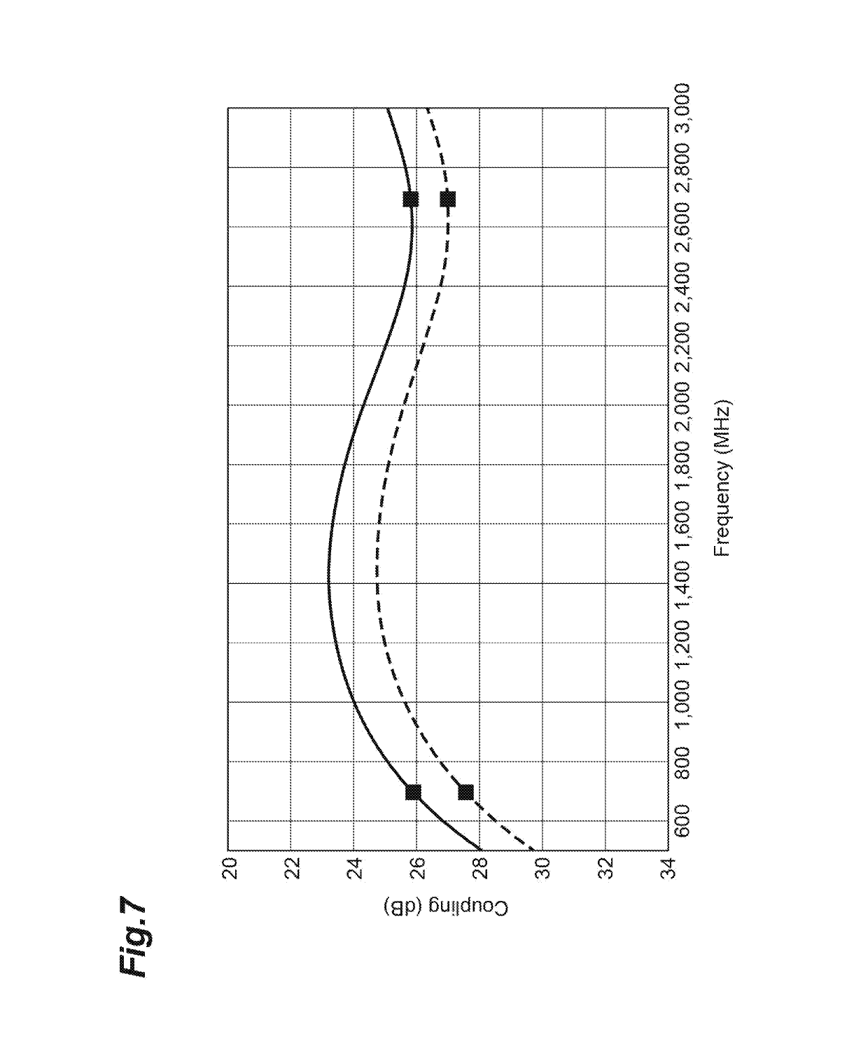

FIG. 7 is a graph showing a relationship between a frequency band and a coupling. In FIG. 7, the horizontal axis represents frequency band (Frequency) [MHz], and the vertical axis represents coupling (Coupling) [dB]. In FIG. 7, results for the electronic component 1 are indicated by the solid line, and results for an electronic component without the capacitor C1 and capacitor C2 are indicated by the broken line. As shown in FIG. 7, it was confirmed that, in the electronic component 1, coupling characteristics were improved as a result of enhanced isolation achieved by providing the capacitor C1 and capacitor C2.

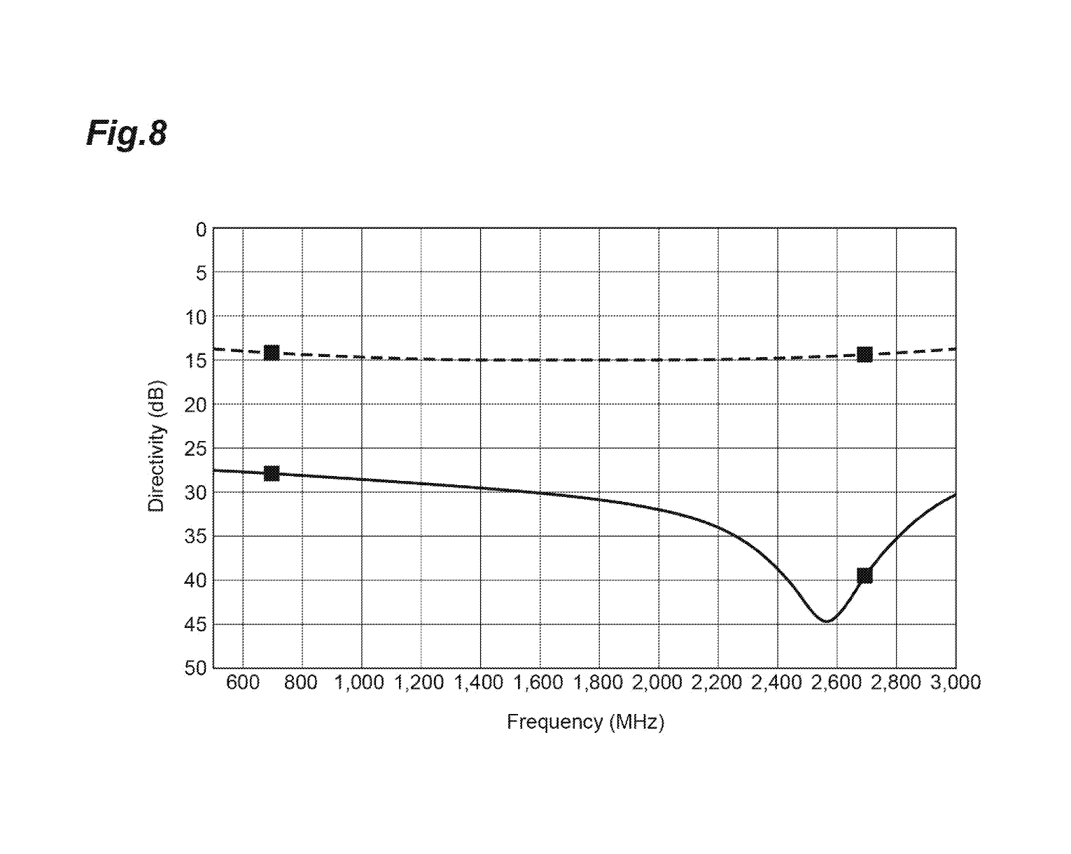

FIG. 8 is a graph showing a relationship between a frequency band and a directivity. In FIG. 8, the horizontal axis indicates frequency band (Frequency) [MHz] and the vertical axis indicates directivity (Directivity) [dB]. In FIG. 8, results for the electronic component 1 are indicated by the solid line, and results for an electronic component without the capacitor C1 and capacitor C2 are indicated by the broken line. As shown in FIG. 8, it was confirmed that, in the electronic component 1, directivity characteristics were improved as a result of enhanced isolation achieved by providing the capacitor C1 and capacitor C2.

In the electronic component 1 according to the present embodiment, the capacitor C1 is constituted by the fifth pattern portion 23E of the conductor pattern 23 of the second conductor layer 11, and the fourth pattern portion 24D and fifth pattern portion 24E of the conductor pattern 24 of the second conductor layer 11. That is, the capacitor C1 is constituted by the plurality of conductors disposed in the same layer (at the same height position). Also, the capacitor C2 is constituted by the sixth pattern portion 24F and seventh pattern portion 24G of the conductor pattern 24 of the second conductor layer 11, and the second pattern portion 25B and third pattern portion 25C of the conductor pattern 25 of the second conductor layer 11. That is, the capacitor C2 is constituted by the plurality of conductors disposed in the same layer (at the same height position).

As described above, in the electronic component 1, since the capacitor C1 and the capacitor C2 are each constituted by the plurality of conductors disposed in the same layer (at the same height position), capacitances of the capacitor C1 and capacitor C2 can be easily adjusted. This configuration is particularly effective for forming minute capacitances in the capacitor C1 and the capacitor C2.

In the electronic component 1 according to the present embodiment, the plurality of conductors may include at least the first conductor, the second conductor, and the third conductor, and the second conductor may be disposed between the first conductor and the third conductor when viewed from the facing direction. In this configuration, the capacitance of the capacitor can be adjusted by adjusting the area over which the adjacent conductors face each other.

In the electronic component 1 according to the present embodiment, the fifth pattern portion 23E is directly connected to the first pattern portion 23A. The fourth pattern portion 24D is directly connected to the first pattern portion 24A. The fifth pattern portion 24E is directly connected to the first pattern portion 24A. The sixth pattern portion 24F is directly connected to the second pattern portion 24B. The seventh pattern portion 24G is directly connected to the second pattern portion 24B. The second pattern portion 25B is directly connected to the first pattern portion 25A. The third pattern portion 25C is directly connected to the first pattern portion 25A. As described above, the patterns (conductors) forming the capacitor C1 and capacitor C2 are directly connected to other patterns, respectively. Thereby, in the electronic component 1, loss can be reduced compared to a case in which the conductor is connected via another conductor. Also, a size of the electronic component 1 can be reduced.

Although the embodiment of the present disclosure has been described above, the present disclosure is not necessarily limited to the above-described embodiment, and various modifications can be made within a range not departing from the gist of the present disclosure.

In the embodiment described above, a form in which the electronic component 1 is a directional coupler has been described as an example. However, the electronic component is not limited to a directional coupler, and may be a filter or the like.

In the above-described embodiment, a form in which the fifth pattern portion 23E, the fourth pattern portion 24D, the fifth pattern portion 24E, the sixth pattern portion 24F, the seventh pattern portion 24G, the second pattern portion 25B, and the third pattern portion 25C are linear has been described as an example. However, the patterns (conductors) forming the capacitor C1 and capacitor C2 are not limited to being linear, and may be curved or the like.

In the above-described embodiment, an example in which the capacitor C1 is constituted by a plurality of conductors disposed in the same layer (at the same height position) has been described. However, the conductors constituting the capacitor C1 may be disposed in different layers. The same applies to the capacitor C2.

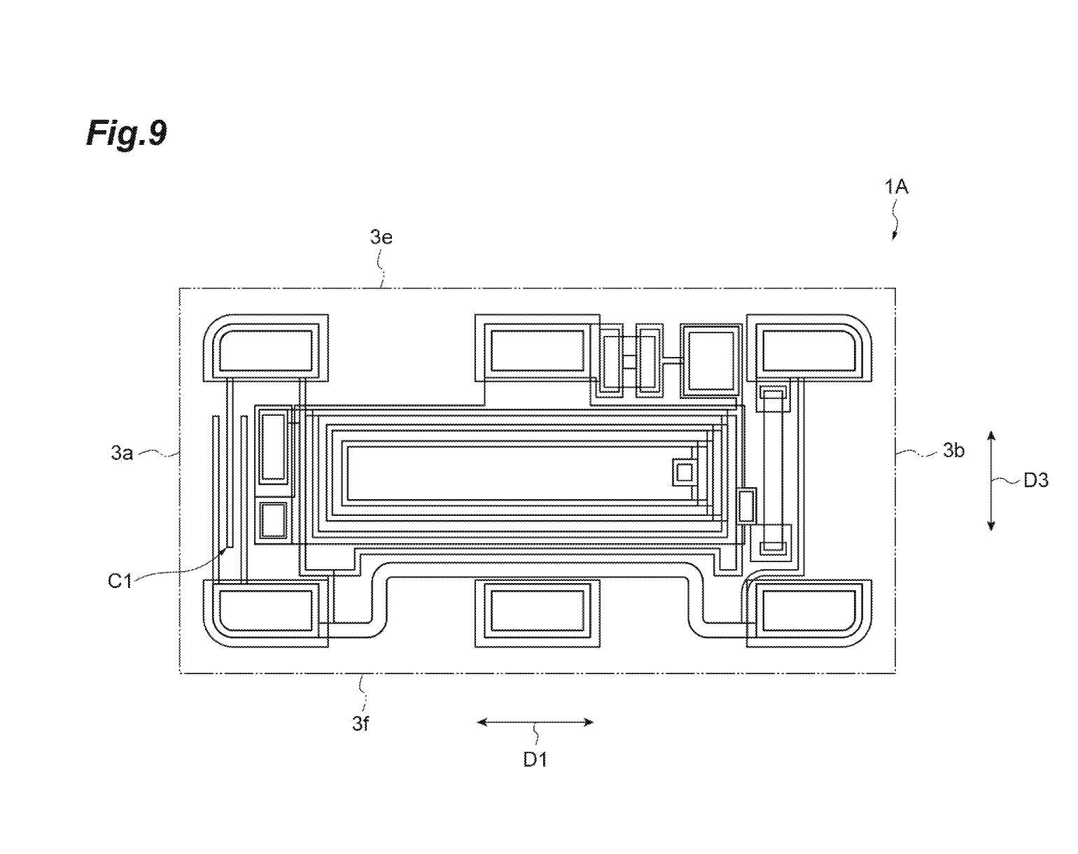

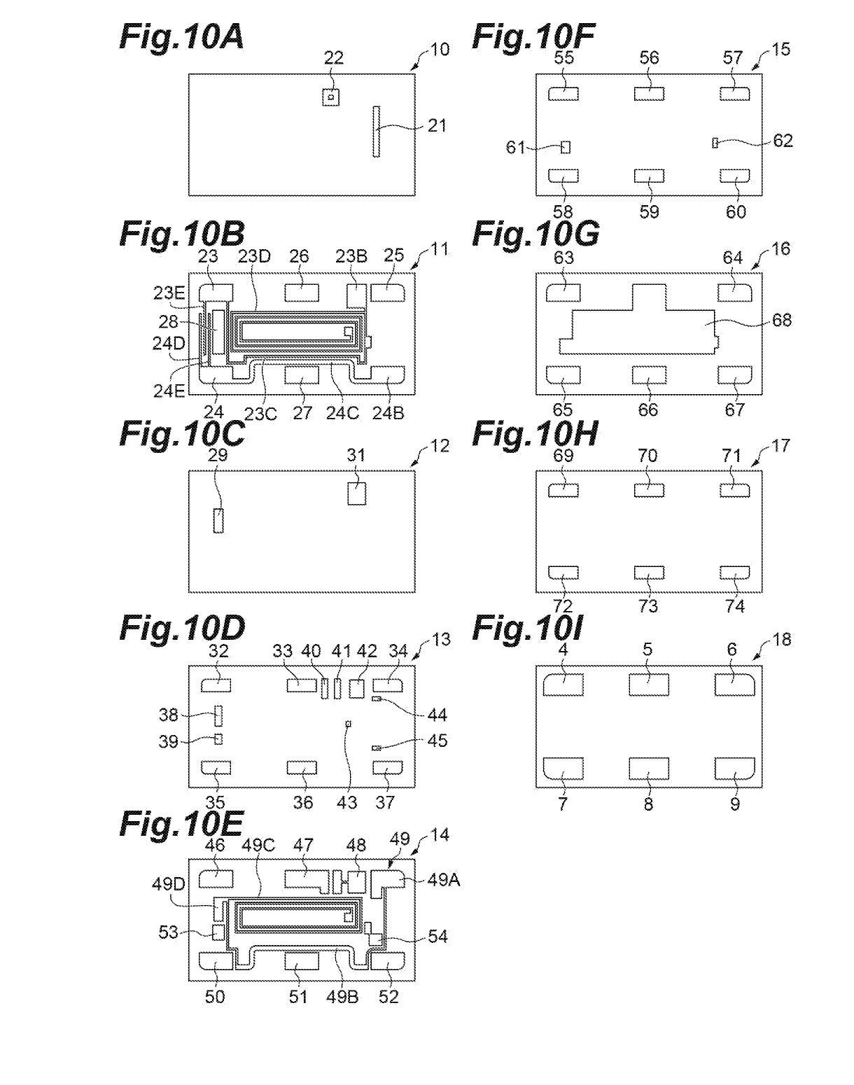

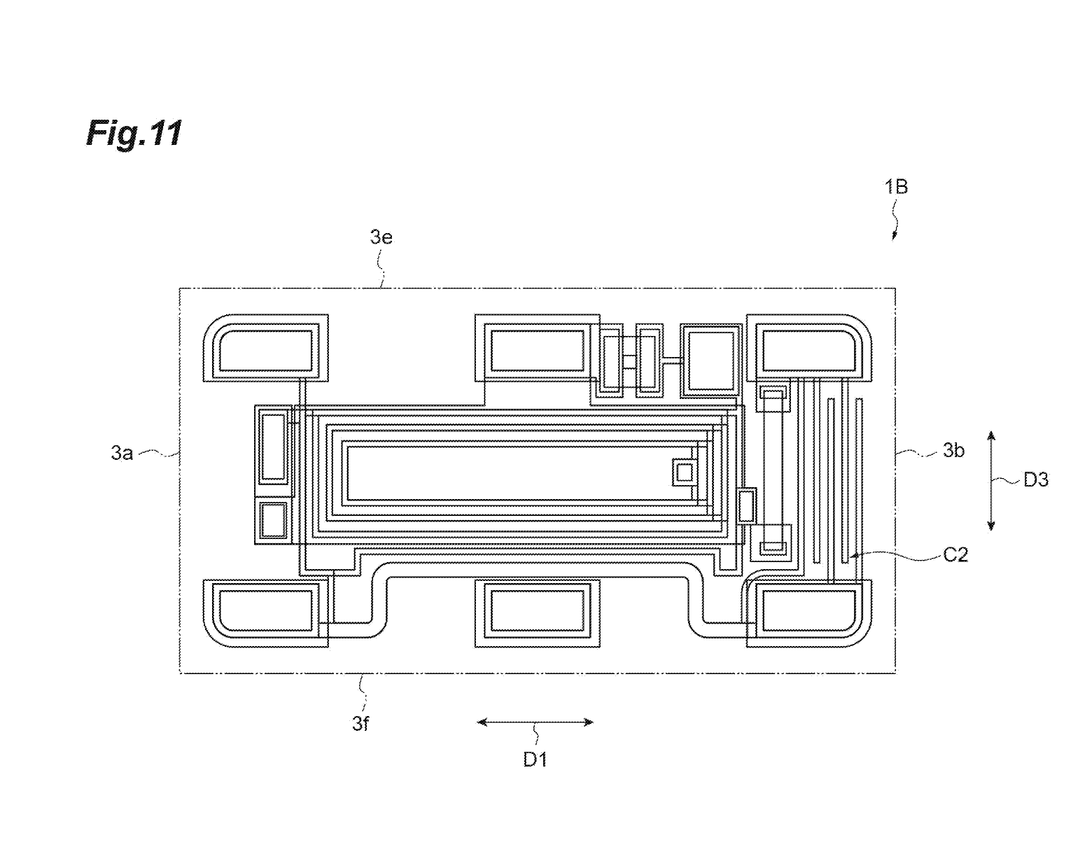

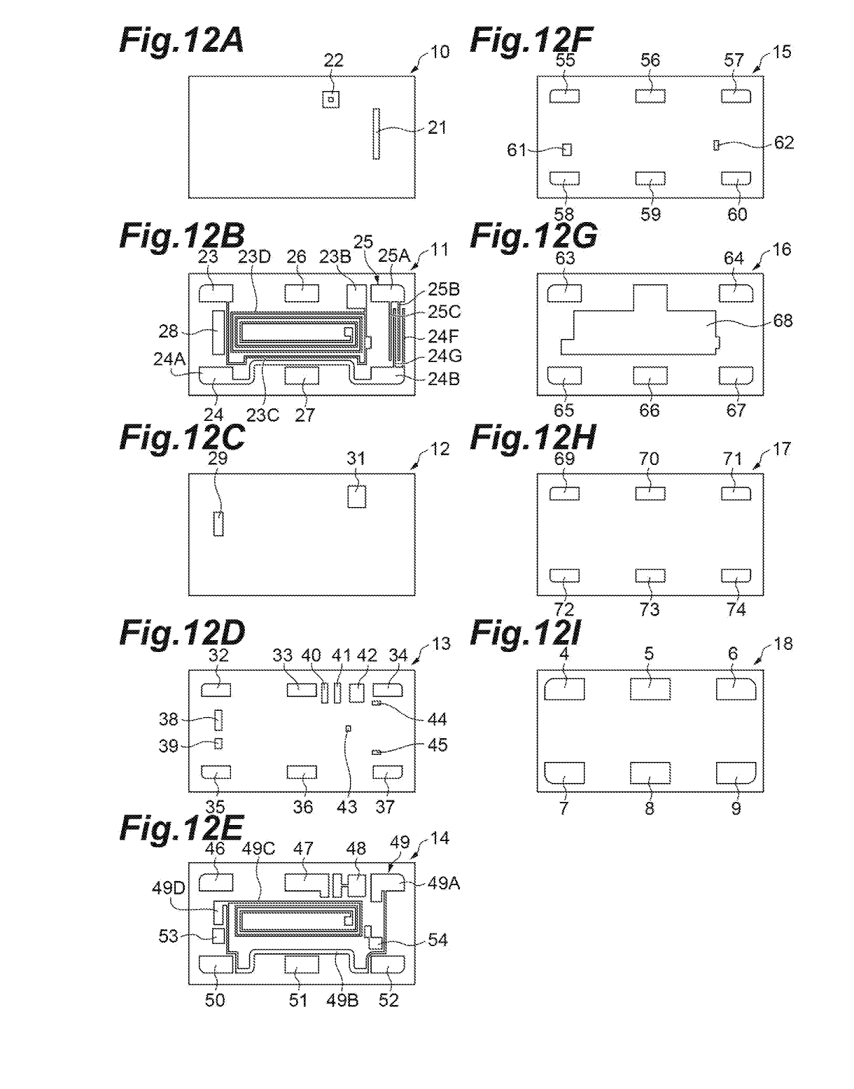

In the above-described embodiment, a form in which the electronic component 1 includes the capacitor C1 and the capacitor C2 has been described as an example. However, as illustrated in FIG. 9 and FIGS. 10A, 10B, 10C, 10D, 10E, 10F, 10G, 10H, and 10I, an electronic component 1A may have only the capacitor C1. Also, as illustrated in FIG. 11 and FIGS. 12A, 12B, 12C, 12D, 12E, 12F, 12G, 12H, and 12I, an electronic component 1B may have only the capacitor C2.

What is claimed is:

1. An electronic component comprising:
a base body having a mounting surface and a main surface facing each other;
a first electrode, a second electrode, a third electrode, and a fourth electrode disposed on the mounting surface;
a first transmission line electrically connecting the first electrode and the second electrode;
a second transmission line electrically connecting the third electrode and the fourth electrode and magnetically coupled to the first transmission line; and
a capacitor provided between the first electrode and the third electrode and/or between the second electrode and the fourth electrode.

2. The electronic component according to claim 1, wherein the capacitor is constituted by a plurality of conductors disposed at the same height position in a facing direction between the mounting surface and the main surface.

3. The electronic component according to claim 2, wherein
the plurality of conductors include at least a first conductor, a second conductor, and a third conductor, and
the second conductor is disposed between the first conductor and the third conductor when viewed from the facing direction.

4. The electronic component according to claim 1, wherein
a first capacitor is provided between the first electrode and the third electrode,
a second capacitor is provided between the second electrode and the fourth electrode, and
a capacitance of the first capacitor is different from a capacitance of the second capacitor.

5. The electronic component according to claim 2, comprising:
a ground electrode disposed on the mounting surface and connected to ground; and
a resistor provided in an electrical path between the ground electrode and the second transmission line.

6. The electronic component according to claim 5, wherein
a first capacitor is provided between the first electrode and the third electrode,
a second capacitor is provided between the second electrode and the fourth electrode, and
the resistor is disposed at a position closer to the plurality of conductors constituting the second capacitor than to the plurality of conductors constituting the first capacitor.

7. The electronic component according to claim 1, comprising a third capacitor and a fourth capacitor provided in an electrical path between the third electrode and the fourth electrode which include the second transmission line.

8. The electronic component according to claim 7, comprising:
a first resistor electrically connected in series to the third capacitor; and
a second resistor electrically connected in parallel to the fourth capacitor.

9. The electronic component according to claim 7, wherein
the capacitor is constituted by a plurality of conductors disposed at the same height position in a facing direction between the mounting surface and the main surface, and
an area of a region in which the plurality of conductors are disposed is larger than an area of the conductors constituting each of the third capacitor and the fourth capacitor.

10. The electronic component according to claim 2, wherein the plurality of conductors are directly connected to any of the conductors connected in the facing direction between the mounting surface and the main surface in each of the first electrode, the second electrode, the third electrode, and the fourth electrode.
